(19) United States
(12) Patent Application Publication
(10) Pub. No.: US 2005/0225500 A1
(43) Pub. Date: Oct. 13, 2005

(54) Image display system having an analog display for displaying matrix signals

(75) Inventor: Albertus Aemilius Seyno Sluyterman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/517,481

(22) PCT Filed: Jun. 11, 2003
(86) PCT No.: PCT/IB03/02218

§ 371 Date: Dec. 7, 2004

(30) Foreign Application Priority Data
Jun. 12, 2002 (EP) 02077294.3

(51) Int. Cl. G09G 1/28

(52) U.S. Cl. 345/22

(57) ABSTRACT

Image display system comprising an analog display (3) for displaying images composed of substantially parallel lines and means for scanning the lines in a scanning direction with a scanning velocity (V). The image display system further comprises processing elements (2), which are adapted to receive a first (VR), a second (VG) and a third (VB) matrix information signal. These information signals (VR,VG,VB) are suitable to be displayed with pixel sub-component precision on a matrix display device having a plurality of pixels. The processing elements (2) are designed to shift the rendering on the display (3) of at least one of the information signals (VR,VG,VB) with respect to another one of the information signals (VR,VG,VB). As a result of this shifting, the information signals (VR,VG,VB) are rendered with sub-component precision on the analog display (3).

The invention relates to an image display system comprising an analog display for displaying first, second and third matrix information signals, which are suitable to be displayed on a matrix display device having a plurality of pixels, each pixel having a plurality of color pixel sub-components and a period of time allocated for transferring information related to one pixel.

A system for rendering matrix information signals with pixel sub-component precision on a matrix display including a plurality of pixels is known from WO 01/09873 A1. When applying the matrix information signals with pixel sub-component precision to an analog display like a cathode ray tube, the rendering of the information on the display screen of the analog display is deteriorated compared to when signals are applied without pixel sub-component precision.

It is an object of the invention to provide a system capable of rendering matrix information signals on the display screen with pixel sub-component precision. The invention is defined by the independent claims. The dependent claims define advantageous embodiments.

If, for example, matrix information signals, adapted to display information with pixel sub-component precision on a matrix display device having a repetitive sub-pixel sequence RGB, represent a white pixel which is shifted over a length of one sub-component, then one of the matrix signals, in this example the first signal, is shifted in time by an amount TP. The result on the matrix display is that, instead of the pixel sequence RGB, now the sequence GBR′ will light up as a white dot, so that a shift of one pixel sub-component has been realized. When applying these matrix information signals directly to an analog device, the information of the first signal would be shifted on the screen by an amount V*TP with respect to the information of the second and third signals, resulting in a deteriorated rendering of the information. However, when applying the shifting of V*TP/N to the matrix information signals applied to the analog display, the white dot on the screen of the analog display would also be shifted by an amount V*TP/N, because the first, second and third information signals are, on average, shifted by V*TP/N. Moreover, the shifting causes the first, second and third signals for generating the white dot to substantially coincide, so that discoloration is avoided. A more detailed explanation is provided in one of the embodiments.

When applying pixel sub-component precision, images are rendered with more detail and sharpness. When the images contain text, the readability of the text is improved. The matrix displays may have three sub-components, but there are also versions which have more sub-components. In the latter case, more differently colored sub-components could be present or a sub-component of a particular color could appear more than once in the sequence.

It is a further advantage if the processing elements comprise time-shifting means adapted to shift in time the first, and the third information signal by an amount of approximately −TP/3 and +TP/3, respectively, with respect to the second information signal. Using time-shifting means is a cost-effective solution, as components and circuitry as used in a conventional system can be applied.

It is also a further advantage if the processing means comprise convergence driving means for supplying a convergence correction signal, and a line convergence adjuster for shifting, upon receipt of the convergence correction signal, the rendering on the screen of:
the first information signal by an amount of substantially V*TP/3 with respect to the second information signal in the counter-scanning direction, and
the third information signal by an amount of substantially V*TP/3 with respect to the second information signal in the scanning direction.

The shifting is now realizable by means of the line convergence adjuster. The basic function of the adjuster in a conventional system comprising an analog display is adjusting the convergence. The same adjuster can be used for realizing the shifting on the screen by supplying one convergence correction signal to the adjuster. In this embodiment, it is generally not necessary to adapt the matrix information signals. Moreover, this is a cost-effective solution of realizing the shifting.

The display system may be a combination of units like a combination of a computer device and a monitor or a combination of video processing equipment and a monitor or a television. The system may also be comprised in one housing or unit like a monitor, television or in a display combined with circuit units.

It is a further advantage if the processing means comprise:
a line convergence adjuster for shifting the rendering on the screen of the first and the third information signal, respectively, with respect to the second information signal in the scanning direction, and
convergence driving means suitable for supplying a convergence correction signal to the line convergence adjuster for shifting the rendering on the screen of the first and the third information signal by an amount of substantially −V*TP/3 and +V*TP/3 and, respectively, with respect to the second information signal.

Making use of the convergence adjuster results in a cost-effective realization of the shifting of the rendering of the first and third information signals.

It is a further advantage if the line convergence adjuster comprises a magnetic quadrupole able to receive a current as the correction signal from the driving means. This quadrupole, which is used to adapt the line convergence, can also be used effectively to realize the shifting. When applying the current, which is a DC-current, having a maximum value at the center of the screen and reducing towards the edges of the screen, the desired shifting is obtained.

It is also advantageous if a switch is present for switching the current ON/OFF. When receiving matrix information signals adapted to render the information with pixel sub-component precision, the current can be switched ON for rendering the matrix information signals with pixel sub-component precision on the analog display. When other signals, which are not adapted to render information with sub-component precision, are received, the current can be switched OFF, thereby allowing correct rendering of the other signals. The switch may be a mechanical switch or an electronic switch, controlled via a user interface or via an automatic detection of the matrix information signals with sub-component precision. The user interface may comprise a button on the device or a remote control device.

These and other aspects of the invention will be further elucidated and described with reference to the drawings, in which:

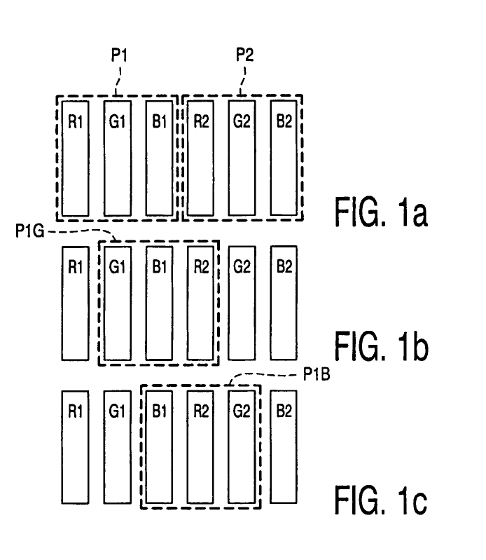

FIG. 1 is a schematic diagram of a matrix display device, not according to the invention, having a plurality of pixels;

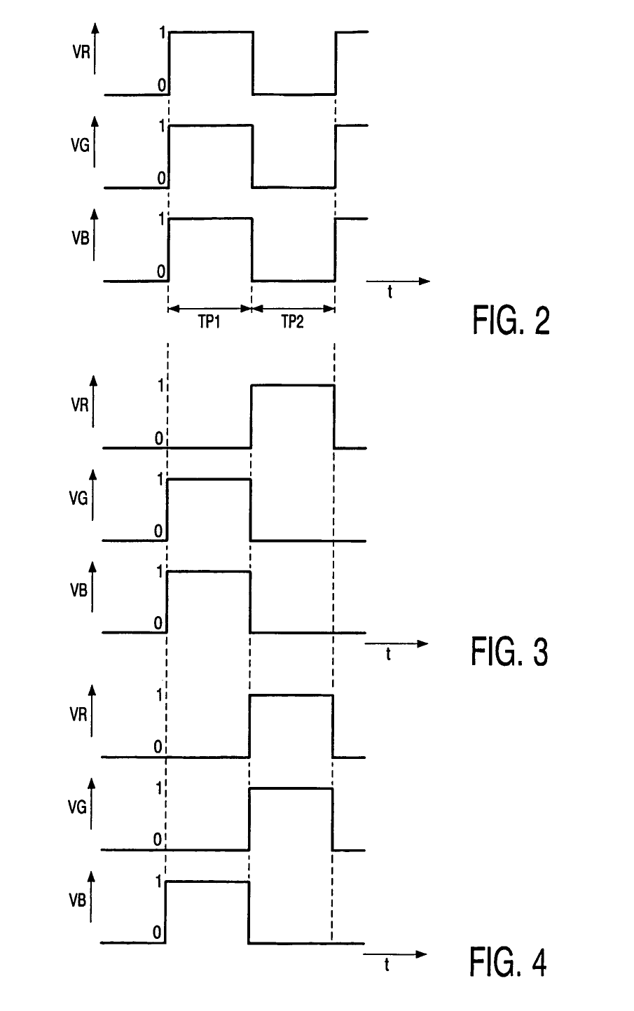

FIGS. 2, 3 and 4 show matrix information signals;

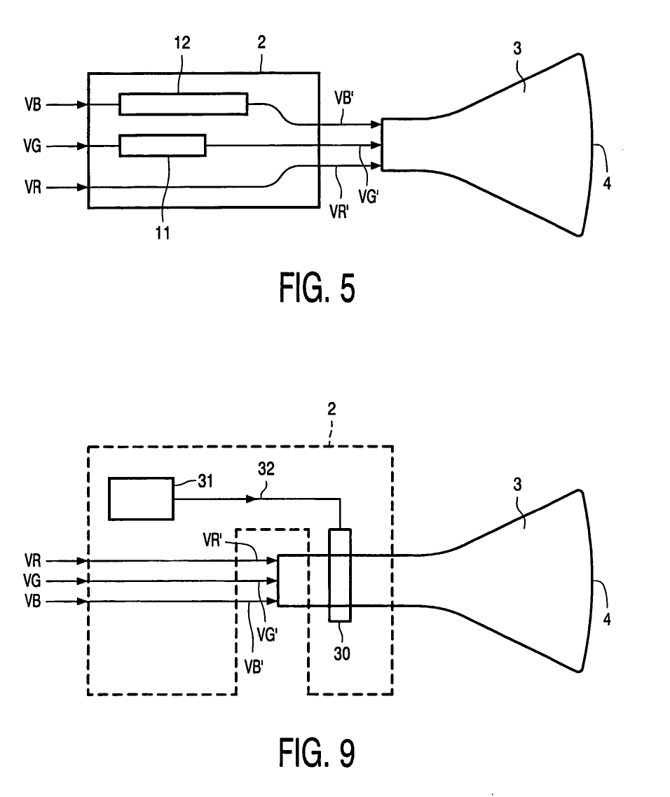

FIG. 5 shows a first embodiment of the display system according to the invention;

FIGS. 6, 7 and 8 show output signals displayed with sub-component precision on an analog display screen;

FIG. 9 shows a second embodiment of a display system according to the invention;

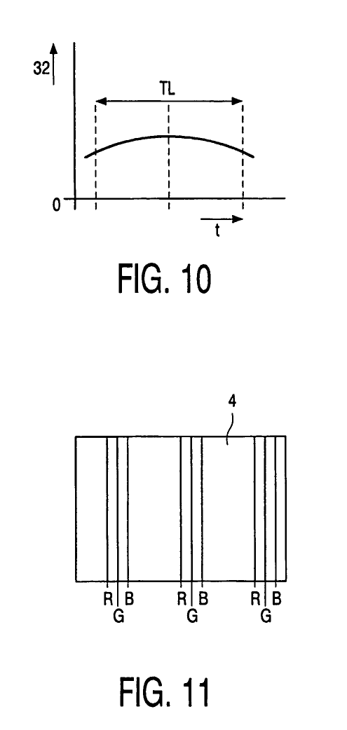

FIG. 10 shows the correction signal of the second embodiment;

FIG. 11 shows how the convergence is shifted on the screen;

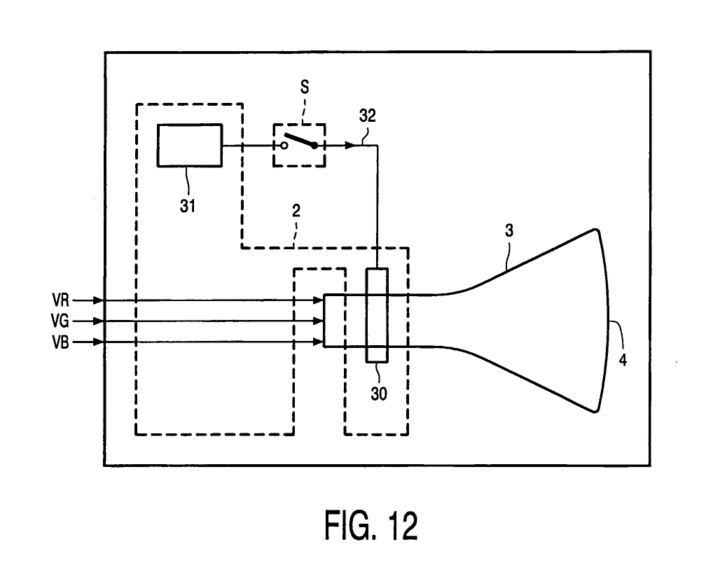

FIG. 12 shows how to add a switch in the second embodiment.

With reference to FIGS. 1 to 4, a simplified explanation will first be given of how information can be displayed with sub-component precision on a matrix display device and how these signals are displayed on an analog display. Thereafter, various embodiments will be presented.

FIGS. 1a, b and c shows two adjacent pixels of the known matrix display, like an LCD display. The pixels are composed of a first trio R1, G1, B1 and a second trio R2, G2, B2 of color sub-components. The two pixels are located next to each other in a row of pixels. Without applying pixel sub-component precision, a white dot can either be created on a location P1, by driving the first trio R1, G1, B1, or at the next location P2 in the same row, by driving the second trio R2, G2, B2 as shown in FIG. 1a. However, when applying matrix information signals adapted to display information with pixel sub-component precision to the matrix display, a white dot can also be created on a location P1G as shown in FIG. 1b. The location P1G is shifted by one sub-component in the row direction as compared to the location P1. This is achieved by driving the color sub-components G1, B1, R2. Likewise as is shown in FIG. 1c a white dot can be created on location P1B by driving color sub-components B1, R2, G2. Consequently, by applying matrix information signals adapted to render information with pixel sub-component precision to a matrix display, the resolution or, in other words, the amount of detail in the row direction can be increased.

When the matrix information comprises text, the readability of the text on the screen can be improved. In such a case, the image is often composed of black letters on a white background. The features that can be rendered with sub-component precision are, amongst others, a width of a “leg” of a symbol, the distance between two legs of a symbol, or the distance between two symbols.

FIGS. 2, 3 and 4 show the matrix information signals VR, VG, VG adapted to display information with sub-component precision on a matrix display as shown in FIG. 1. FIG. 2 shows the matrix information signals VR, VG, VB as a function of time t for creating a white spot on the location P1. The voltage level corresponding to no light output is indicated by a level 0, while the level corresponding to maximum light output is indicated by a level 1. When all matrix information signals VR, VG, VB have the level 1 during a period of time TP1, associated with driving the color sub-components R1, G1, B1, a white dot is displayed on location P1. Likewise, a level 0 of the matrix information signals during a period of time TP2, associated with driving the sub-components R2, G2, B2, means that a black dot is displayed on location P2. If, for example, a white dot should be displayed on location P1G, the signals VR, VG, VB according to FIG. 3 should be supplied. As is shown in FIG. 3, the first matrix information signal VR is delayed by a period of time TP1 compared to the situation in FIG. 2. The effect is that sub-components G1, B1, R2 will light up, resulting in a white dot on the location P1G as shown in FIG. 1. Consequently, the white dot on the matrix display has been shifted by an amount corresponding to one sub-component or, in other words, white dots are positioned with sub-component precision on a row of a matrix display. Likewise, FIG. 4 shows the matrix information signals VR, VG, VB for displaying a white spot on the location P1B as shown in FIG. 1. The above simplified explanation illustrates how according to the prior art matrix information signals are adapted to display information with sub-component precision on a matrix display.

When applying the information signals VR, VG, VB as shown in FIG. 2 to an analog display 3 like a cathode ray tube a white spot would be displayed correctly on the screen of the analog display 3 on a location corresponding to period of time TP1.

However, when applying the information signals VR, VG, VB as shown in FIG. 3 to an analog display 3, a dot having green and blue sub-components would be displayed on the location corresponding to time TP1 and, next to this dot, a red dot would be displayed on a location shifted over a distance V*TP1 compared to the green-blue dot, wherein V is the scanning velocity in the scanning direction of the analog display 3. The matrix information suitable to be displayed with pixel sub-component precision on a matrix display is thus not rendered correctly on an analog display 3. Likewise, the information signal VR, VG, VB as shown in FIG. 4 will not be rendered correctly on the analog display 3. A blue dot will be visible on the location corresponding to time TP1 and, next to this dot, a red-green dot will be visible.

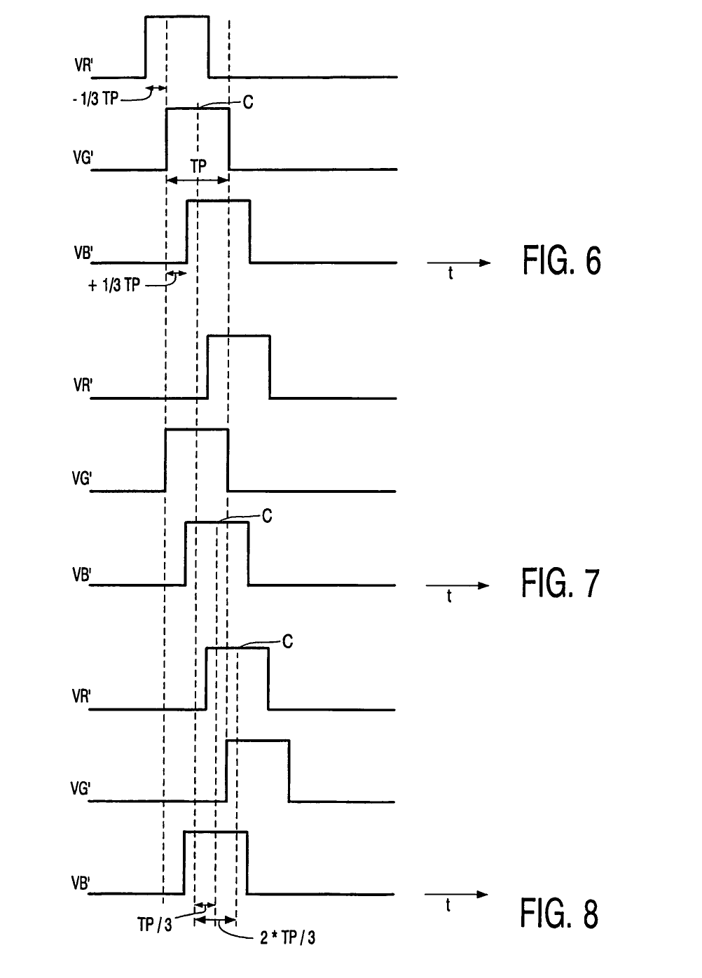

In a display system according to the first embodiment as shown in FIG. 5, processing elements 2 are present for receiving the matrix information signals VR, VG, VB as shown in FIGS. 2, 3 and 4 and the analog display 3 has a display screen 4. The signals VR, VG, VB have a period of time TP allocated for transferring information related to one pixel. The processing elements 2 comprise a first delay circuit 11 for delaying the second information signal VG and a second delay circuit 12 for delaying the third information signal VB. The first information signal VR is not delayed by the processing elements 2. The output signals VR′, VG′, VB′ of the processing elements 2, being the delayed matrix information signals VR, VG, VB, are coupled to the analog display 3, which may be a cathode ray tube. The analog display 3 has a display screen 4 for displaying images composed of substantially parallel lines extending in a scanning direction. The display 3 is able to scan the lines in a scanning direction with a scanning velocity V. The delay time of the first delay circuit 11 is TP/3. The delay time of the second delay circuit 12 is 2*TP/3. When taking the timing of the second information signal VG as a reference, the effect is that the first information signal VR is advanced in time by an amount TP/3, while the third information signal VB is delayed in time by an amount TP/3 with respect to the second information signal VG. When applying the information signals shown in FIGS. 2 to 4 to the above described processing elements 2 the resulting output signals VR′, VG′, VB′ will have timing diagrams as shown in FIGS. 6 to 8. FIG. 6 shows the output signals VR′, VG′, VB′ resulting from input signals according to FIG. 2. FIG. 7 shows the output signals VR′, VG′, VB′ resulting from input signals according to FIG. 3. FIG. 8 shows the output signals VR′, VG′, VB′ resulting from input signals according to FIG. 4. As can be seen from FIGS. 6 to 8, the center C of the output signals VR′, VG′, VB′ is shifted in the situation of FIG. 7 by an amount TP/3 with respect to the situation in FIG. 6 and in the situation of FIG. 8 by an amount 2*TP/3. When displaying the output signals VR′, VG′, VB′ according to FIGS. 6 to 8 on the screen 4, the resulting white spot is either not shifted (situation of FIG. 6), is shifted by an amount V*TP/3 in the situation of FIG. 7 or is shifted by an amount 2*V*TP/3 in the situation of FIG. 8. The spots are thus rendered with pixel sub-component precision on locations corresponding to the locations P1, P1G and P1B as shown in FIG. 1.

The invention, illustrated in the above embodiment with three color sub-components, can be generalized for a situation where a plurality N of color sub-components is present. In that case, the matrix information signals VR, VG, VB comprise N signals, each of which (except one “center signal”) has to be shifted in time by an amount proportional to TP/N with respect to the center signal. By applying appropriate time shifts as illustrated above for the example N=3, a white spot can be shifted on the screen 4 by amounts of V*TP/N.

In a second embodiment as shown in FIG. 9, the display system comprises processing elements 2 receiving the matrix information signals VR, VG, VB. The same reference numerals are applied as in the first embodiment for items having a similar function as described in the first embodiment. The processing elements 2 comprise a convergence driving unit 31 and a line convergence adjuster 30. The line convergence adjuster 30 is mounted on the neck of the analog display 3, having display screen 4. The processing elements 2 supply the output signals VR′, VG′, VB′ to the analog display 3. As no special processing of the matrix information signals VR, VG, VB is required in this second embodiment compared to a conventional display system, this part of the processing elements 2 will not be further discussed here. The convergence driving unit 31 supplies a convergence correction signal 32 to the line convergence adjuster 30. The line convergence adjuster 30 may be a magnetic quadrupole comprising one or more coils as is often present in a conventional display system for adjusting the convergence of the analog display 3. By applying a correction signal 32 in the form of a current applied to the coils of the quadrupole 30 as shown in FIG. 10, the convergence is shifted as shown in FIG. 11. The current as a function of time t as shown in FIG. 10 is shown for the duration TL required to scan one line. The current has a maximum when scanning the middle of a line and decreases towards the beginning and end of a line.

The effect shown in FIG. 11 is that, on the screen 4 of the analog display 3, designed for three primary colors red, green and blue the red information R is shifted to the left (in the counter-scanning direction) and the blue information B is shifted to the right (in the scanning direction) with respect to the green information G. When, for example, conventional information signals representing three narrow vertical white bars are applied to the display 3, three sets of red, green and blue colored vertical bars RGB are thus visible as shown in FIG. 11. As can be concluded from this example, the correction signal 32 can create the same shift on the screen as the time shift disclosed in the first embodiment.

FIG. 12 shows how in the second embodiment a switch S can be added for switching the current ON/OFF (being the correction signal 32) depending on whether information signals VR, VG, VB, which can be rendered with sub-component precision, are received. The switch S can be activated by a user via a suitable user interface, but could also be activated via an automatic detection circuit, which detects whether information signals VR, VG, VB which can be rendered with sub-component precision, are present.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim use of the article “a” or “an” preceding an element does not exclude the presence of a plurality of such elements. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. An image display system comprising:
an analog display for displaying images composed of substantially parallel lines and having a display screen;
means for scanning the lines in a scanning direction with a scanning velocity V;
processing means for receiving a first, a second and a third matrix information signal suitable to be displayed on a matrix display device having a plurality of pixels, each pixel having a plurality N of colored pixel sub-components and a period TP of time allocated for transferring information related to one pixel to shift the rendering on the screen of at least one of the information signals with respect to another one of the information signals by an amount proportional to V*TP/N.

2. A system as claimed in claim 1, characterized in that each pixel has a predetermined sequence of a red, a green and a blue sub-component, the processing means being arranged to shift, by an amount of substantially V*TP/3 with respect to the second information signal containing information about the green sub-component, the first information signal containing information about the red sub-component in the counter-scanning direction, and the third information signal containing information about the blue sub-component, in the scanning direction.

3. A system as claimed in claim 2, characterized in that the processing elements comprise time shifting means adapted to shift in time the first and the third information signal by an amount of approximately −TP/3, and +TP/3, respectively, with respect to the second information signal.

4. A system as claimed in claim 2, characterized in that the processing elements comprise:
convergence driving means for supplying a convergence correction signal, and
a line convergence adjuster for shifting, upon receipt of the convergence correction signal, the rendering on the screen of:
the first information signal by an amount of substantially V*TP/3 with respect to the second information signal in the counter-scanning direction, and
the third information signal by an amount of substantially V*TP/3 with respect to the second information signal in the scanning direction.

5. A system as claimed in claim 4, characterized in that the line convergence adjuster comprises a magnetic quadrupole able to receive a current as the correction signal from the driving means.

6. A system as claimed in claim 5, characterized in that a switch is present for switching the current ON/OFF.
